(19) United States
(12) Patent Application Publication
(10) Pub. No.: US 2009/0086686 A1
(43) Pub. Date: Apr. 2, 2009

(54) METHOD TO SIMPLIFY UPLINK STATE FLAG (USF) DECODING COMPLEXITY FOR REDHOT A AND B WIRELESS TRANSMIT/RECEIVE UNITS

(75) Inventors: Marian Rudolf, Montreal (CA); Stephen G. Dick, Nesconset, NY (US); Prabhakar R. Chitrapu, Blue Bell, PA (US); Behrouz Aghili, Melville, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/241,834

(22) Filed: Sep. 30, 2008

Related U.S. Application Data
(60) Provisional application No. 60/976,553, filed on Oct. 1, 2007.
(60) Provisional application No. 61/033,256, filed on Mar. 3, 2008.

(51) Int. Cl. H04J 3/00; H04W 8/00

(52) U.S. Cl. 370/336; 370/329

(57) ABSTRACT

A method and apparatus allow for reliable and low-complexity decoding of EGPRS2 communication bursts when RTTI and BTTI equipment operate on the same timeslot(s). Various configurations for the Uplink State Flag (USF) mapping employ adjustable bit swapping of some or all USF channel-coded bits in communication bursts. Configurations that allow for an adjustable use of the symbol mapping stage in the transmitter and receiver to allow for more throughput and/or reduced complexity are also disclosed. Admissible mapping rules are known to the receiver and transmitter and therefore reduce the complexity of decoding this information. In order to increase throughput for EGPRS2 communication bursts, RTTI transmissions of different modulation types or EGPRS/EGPRS2 modulation and coding schemes during a BTTI interval are introduced that allow for reliable USF decoding and reduced decoder complexity.

### CROSS REFERENCE TO RELATED APPLICATIONS

This application claims the benefit of U.S. Provisional Application Ser. No. 60/976,553 filed on Oct. 1, 2007, and U.S. Provisional Application Ser. No. 61/033,256 filed on Mar. 3, 2008 which are incorporated by reference as if fully set forth.

### TECHNICAL FIELD

This application is related to wireless communications.

### BACKGROUND

The global system for mobile communications (GSM) standard, release 7 (R7) introduces several features that improve throughput in the uplink (UL) and downlink (DL) and reduce latency of transmissions. Among these features, GSM R7 introduces enhanced general packet radio service 2 (EGPRS-2) to improve throughput for the DL and the UL. EGPRS-2 throughput improvements in the DL are known as the REDHOT (RH) feature, and improvements for the UL are known as the HUGE feature. EGPRS-2 DL and REDHOT are synonymous.

In addition to legacy enhanced general packet radio service (EGPRS) modulation and coding schemes (MCS) based on Gaussian minimum shift keying (GMSK) (MCS-1 through MCS-4) and 8 phase-shift keying (8PSK) modulations (MCS-5 through MCS-9), REDHOT uses quadrature PSK (QPSK), 16 quadrature amplitude modulation (16QAM) and 32QAM modulations. Another technique for improving throughput is the use of Turbo coding (as opposed to Convolutional Coding with EGPRS). Furthermore, operation at higher symbol rate (1.2× symbol rate of legacy) is another improvement.

A network and/or a wireless transmit/receive unit (WTRU) supporting REDHOT can implement either REDHOT Level A (RH-A) or REDHOT Level B (RH-B). While a WTRU implementing RH-B will achieve maximum throughput gain by using the full set of performance-improving features defined for REDHOT, a RH-A WTRU that implements a chosen subset of improvement techniques will still achieve a net improvement over legacy EGPRS. The RH-A solution will also be easier to implement than a full RH-B implementation.

Specifically, RH-A will implement eight (8) new MCSs, using 8PSK, 16QAM and 32QAM modulation. These are called downlink Level A MCS (DAS)-5 through DAS-12. RH-B, will implement another set of eight (8) new MCSs, based on QPSK, 16QAM and 32QAM modulations. These are called downlink Level B MCS (DBS)-5 through DBS-12. Unlike legacy EGPRS, both RH-A and RH-B use Turbo coding for the data portions of the radio block. For link adaptation purposes, both RH-A and RH-B WTRUs will reuse legacy EGPRS MCS-1 through MCS-4 (all based on GMSK modulation). In addition, RH-A will also re-use legacy EGPRS MCS-7 and MCS-8 for link adaptation, and RH-B will re-use legacy EGPRS MCS-8 and RH-A DAS-6, DAS-9 and DAS-1 for link adaptation. Therefore, a RH-A WTRU will support MCS-1 through MCS-4, MCS-7 through MCS-8, and DAS-5 through DAS-12 and an RH-B WTRU will support MCS-1 through MCS-4, MCS-8, DAS-6, DAS-9, DAS-11, and DBS-5 through DBS-12. However, a RH-A WTRU will exclusively operate at legacy (low) EGPRS symbol rate (LSR), while RH-B WTRU is capable of operating at higher symbol rate (HSR). A RH-B WTRU is required to implement functionality according to RH-A and RH-B specifications. However, when a RH-B WTRU is configured to receive packet data, it will either operate in legacy EGPRS mode, RH-A or RH-B mode.

Legacy EGPRS and the new types of RH-A and RH-B WTRUs may operate together on the same timeslot and the principle of legacy EGPRS uplink state flag (USF) operation and PAN decoding in conjunction with the GSM R7 Latency Reduced (LATRED) features are possible (with certain restrictions).

RH-A and RH-B WTRUs are required to decode the USFs of received radio blocks on the assigned timeslot(s). In addition, for forward-compatibility reasons, RH-B WTRUs are required to implement functionality that allows them to distinguish between RH-A and RH-B modulated bursts (DAS-x modulation and coding schemes versus DBS-x). This latter requirement exists in order to increase shared channel utilization and to reduce the radio planning effort for operators due to the fact that resources (e.g., timeslots) can easily be pooled together for RH-A and RH-B mobile stations.

The USF is made up of three (3) information bits that are encoded into a varying number of bits depending upon the coding scheme (CS) used. In GPRS, in order to decode the USF, the WTRU first decodes the stealing flags which indicate if GPRS CS-1, CS-2, CS-3 or CS-4 is used. There is exactly one (1) stealing flag before the training sequence in each burst, and one (1) stealing flag after the training sequence in each burst, making a total of eight (8) stealing flags in a radio block.

GPRS sets these stealing flags in accordance with the following:

q(0), q(1), . . . , q(7)=all 1's identifies the coding scheme CS-1;

q(0), q(1), . . . , q(7)=1,1,0,0,1,0,0,0 identifies the coding scheme CS-2;

q(0), q(1), . . . , q(7)=0,0,1,0,0,0,0,1 identifies the coding scheme CS-3; and

q(0), q(1), . . . , q(7)=0,0,0,1,0,1,1,0 identifies the coding scheme CS-4.

In the case of GPRS CS-1 through CS-3, the USF is encoded by a convolutional code together with the rest of the radio link control (RLC)/medium access control (MAC) header and the data portion. Therefore, decoding of the entire radio block (4 bursts) is required to extract the USF. In the case of CS-4 however, the 3 USF info bits are block encoded into 12 coded bits, and mapped separately from the RLC/MAC header and data portions of the radio block. The USF can be extracted without decoding the entire radio block.

In the case of GPRS CS-4, the 12 coded USF bits are contained in the following symbol positions distributed across the data portion of the bursts:

(1) {0,50,100} in the 1st burst;

(2) {34,84,98} in the 2nd burst;

(3) {18, 68, 82} in the 3rd burst; and

(4) {2,52,66} in the 4th (last) burst of the radio block.

FIG. 3 shows burst mapping for a USF sent in 20 ms. The coded USF bits are placed in different symbol positions, depending on the burst in the radio block. Because all bursts are GMSK modulated (1 bit per symbol), the symbol position equals the bit position. Because these bit positions are known and fixed, it is not necessary to decode the entire RLC/MAC header and the entire data portion of the radio block in order to read the USF (unlike CS-1 through CS-3 coding schemes). However, equalization of the data portion is still an issue, because inter-symbol interference (ISI) from the data symbols distorts the USF symbols contained in their middle.

An EGPRS capable WTRU is required to decode the USF of EGPRS radio blocks. EGPRS radio blocks can be either GMSK modulated (MCS-1 through MCS-4) or 8PSK modulated (MCS-5 through MCS-9). While initially GPRS WTRUs could not receive 8PSK modulated blocks, a solution for GMSK modulated EGPRS radio blocks is to encode the USF and place the 12 block-coded USF bits of the GMSK modulated EGPRS radio blocks in exactly the same manner as defined by the legacy GPRS coding scheme, CS-4. The GPRS WTRU is thus led to believe that a CS-4 radio block is received by putting stealing bits in the GMSK modulated EGPRS radio blocks in the exact same positions as in the legacy GPRS radio blocks, and setting these stealing flags to the codeword for CS-4.

GPRS CS-4 and therefore implicitly EGPRS MCS-1 through MCS-4 is indicated by setting the stealing bits to 00010110. Consequently, the GPRS WTRU will successfully (unless the radio conditions are too poor) decode the USF, believing the block is a CS-4 radio block. Subsequently, the GPRS WTRU will attempt to decode the rest of the EGPRS radio block as a CS-4 block and fail (due to a cyclic redundancy check (CRC) failure). EGPRS WTRUs will also read the legacy stealing bits, but for the EGPRS WTRU the CS-4 stealing bit code word means that an EGPRS radio block has been sent (MCS-1 through MCS-4). Consequently, it decodes the USF assuming this, and this will succeed since the USF is placed in the correct position (same as for CS-4). Subsequently, to determine which modulation and coding scheme (e.g. MCS-1 through MCS-4) has been used, the EGPRS WTRU decodes the RLC/MAC header and looks at the coding and puncturing scheme (CPS) field, and decodes the rest of the radio block. If the radio block actually was a CS-4 radio block, this latter part will fail (due to a CRC failure during RLC/MAC header decoding).

When EGPRS MCS-5 through MCS-9 are used (all 8PSK), the 3 bit USF is block-coded into thirty-six (36) bits, and as in the case of CS-4 and MCS-1 through MCS-4, treated independently from the RLC/MAC header and data portions in the radio block. However, unlike CS-4 and MCS-1 through MCS-4, these thirty-six (36) block-coded USF bits are mapped into the very same set of bit positions, {150, 151, 168-169, 171-172, 177, 178 and 195} in each of the 4 bursts making up the radio block.

FIG. 4 shows a burst mapping for MCS-5 and MCS-6 before and after bit swapping. FIG. 5 shows burst mapping for MCS-7, MCS-8 and MCS-9 before and after bit swapping.

A WTRU distinguishes between GMSK-modulated radio blocks (CS-4 and MCS-1 through MCS-4) and 8PSK-modulated radio blocks (MCS-5 through MCS-9) by detecting the correct phase rotation on the training sequence of the bursts. Subsequently, the WTRU needs to configure the decoder appropriately in order to extract the USF symbols/bits from the correct position, because the USF bit mapping in the GMSK bursts (MCS-1 through MCS-4) is different from the mapping used on the 8PSK bursts (MCS-5 through MCS-9).

In GSM Enhanced Data rates for Global Evolution (Edge) Radio Access Network (GERAN), USF coding is accomplished in a similar manner as in EGPRS MCS-5 through MCS-9 for the new 8PSK based DAS-5 through DAS-7 schemes. This means 3 USF bits are block-coded into 36 total USF coded bits and mapped into the very same set of bit positions {150, 151, 168-169, 171-172, 177, 178 and 195} for each of the 4 bursts making up the radio block as described for the legacy EGPRS MCS-5 through MCS-9 case.

For the new 16QAM based DAS-8 and DAS-9 schemes, the 3 USF bits get block coded into 48 total USF coded bits. These then get mapped to bit positions 232 to 243 in each of the 4 bursts making up the radio block. This means the USF is mapped into the three (3) 16QAM symbols immediately following the training sequence.

For the new 32QAM based DAS-10 through DAS-12 schemes, the 3 USF bits are coded into 60 total USF channel coded bits. These are then mapped to bit positions 290 to 304 in each of the four (4) bursts making up the radio block. This means the USF are mapped into the three (3) 32QAM symbols immediately following the training sequence.

For all new RH-A schemes DAS-5 through DAS-12, the bit positions containing the channel-coded USF bits are fixed and exactly the same in all four (4) bursts making up the Radio Block. However, there are 3 types of different USF coding tables to support and 2 different sets of USF positions in the REDHOT bursts. In a RH-A WTRU, USF coding is accomplished as described by CS-4/MCS-1 to MCS-4 and therefore the RH-A WTRU must also support legacy EGPRS MCS-1 through MCS-4 on the REDHOT timeslots. Because of this, a RH-A WTRU must support a total of 4 types of USF coding tables and 3 different sets of USF positions. Also note that extraction of the USF for legacy MCS-1 through MCS-4, as well as for DAS-5 through DAS-7, still requires equalization of the data portion of the burst because the USF coded bits are contained in the middle of these bursts. This is not necessary for DAS-8 through DAS-12 where only equalization with the ISI from the training sequence is required, because the 3 USF symbols trail the midamble just before the data portion starts.

Since a RH-B WTRU must be capable of extracting the USF even when bursts are sent using any of the new RH-A DAS-5 through DAS-12 schemes, the number of USF coding tables and USF bit position mapping tables further increases, as described below.

The new type of RH-B bursts (DBS-5 through DBS-12) place the USF into the 4 symbols immediately following the training sequence. This allows for extraction of the USF bits by RH-B WTRUs without requiring the WTRUs to equalize the whole burst. Similar to RH-A, since modulation type detection and channel estimation based on the training sequence is always needed initially, the USF is placed next to the training sequence. Thus, a RH-B WTRU needs only to detect the training sequence and the adjacent USF symbols. The USF is placed after the midamble. The reason for this is that typical channel impulse responses have only relatively small precursors (for example, on the order of several nano-seconds) but larger post cursors (for example, on the order of several micro-seconds). When the USF follows the training sequence immediately, the most critical ISI on the USF symbols will be generated directly by the training sequence and the USF symbols themselves. Hence it is not necessary to equalize payload symbols.

In GERAN, four (4) USF symbols per RH-B burst (and therefore 4×4=16 symbols total per radio block) are used. This translates into 16×2=32, 16×4=64 and 16×5=80 bit positions taken away from the RLC/MAC header, piggybacked positive acknowledgement (ACK)/negative acknowledgement (NACK), (PAN), if present, and data portions of the burst for QPSK (DBS-5-6), 16QAM (DBS-7 through DBS-9) and 32QAM (DBS-10 through DBS-12) modulations respectively. Since QPSK is part of RH-B, the concept must work with four quaternary symbols per burst. Therefore, the basic mapping of USF channel coded bits into symbols uses QPSK, and is then extended to 16-QAM and 32-QAM burst formats by using only 4 corner constellation points out of the 16 or 32 constellation points.

For all new RH-B burst formats DBS-5 through DBS-12, the three (3) bit USF is always coded into a 16 bit long coded USF. For each burst, four (4) USF coded bits are mapped onto the four (4) symbols immediately following the training sequence. The first two (2) USF coded bits are mapped onto the first symbol, and the second symbol contains a phase-rotated replica of the first symbol. The same principle applies to a second group of two (2) USF coded bits mapped into the third and fourth symbols. The mapping onto four (4) symbols for RH-B bursts is shown in FIG. 6.

Specifically, a RH-B WTRU must perform modulation-type detection for GMSK, 8PSK, QPSK, 16QAM and 32QAM. This is done through correlation with phase-rotated versions of the midamble dependent upon the modulation-type employed. In addition, correlation for 16QAM and 32QAM must be done for both legacy symbol rates and the new higher symbol rates.

Subsequently, the WTRU must reconfigure its receiver depending on the modulation-type detected. For example, if GMSK (MCS-1 through MCS-4) is detected, the WTRU extracts the USF from the first set of positions (as described above). If 8PSK (DAS-5 through DAS-7) is detected, the WTRU extracts the USF from a second set of positions as described above, and employs a different mapping table. In both cases the WTRU equalizes the data portion of the burst to process the USF. If 16QAM or 32QAM is detected, the WTRU processes either three (3) or four (4) symbols in yet a third set of USF positions, depending on whether HSR (RH-B) or LSR (RH-A) is detected. In these latter cases, the WTRU equalizes any portion of the data in the burst, because the USF symbols trail the midamble. With GMSK and 8PSK types of bursts, the USF is in the middle of the data portions before and after the midamble, therefore the entire burst needs to be equalized in order to extract the USF. With QPSK/16QAM/32QAM MCSs, the USF follows the midamble, and only interference from the midamble needs cancellation prior to extracting the USF symbols.

Because a RH-B WTRU must implement all of the functionality of a RH-A WTRU, a significant level of complexity is required. While a WTRU may not receive a data or control block transmission in every radio block on its assigned timeslot(s), and it may discard the remainder of the received block once it is determined that the block was intended for another WTRU, the WTRU is still required to extract and process the USF field on any such received block, even though it may be addressed to another WTRU. Another drawback is that this approach results in significant WTRU processing latencies in the receiver. Yet another issue is that the RH-A WTRU needs to equalize all or at least a significant fraction of the data portion of the burst dedicated to USF extraction because EGPRS MCS-1 through MCS-4 and DAS-5 through DAS-7 map the USF symbols somewhere into the middle of the burst.

Therefore, a method for reducing USF decoding complexity for RH WTRUs is highly desirable.

An additional complication for USF decoding in EGPRS2 arises from operation in conjunction with reduced transmission time interval (RTTI) transmission formats provided by the GSM Release 7 LATRED feature. Before Release 7, legacy EGPRS provides only for the possibility of the legacy transmission format using the basic transmission time interval (BTTI). A typical BTTI transmission includes four (4) bursts making up the legacy EGPRS radio block sent on the same assigned timeslot per frame over four (4) consecutive frames. For example, if a WTRU is assigned timeslot (TS) #3, the WTRU would receive an entire radio block by extracting burst #1 from TS #3 in GSM frame N, burst #2 from TS #3 in GSM frame N+1, burst #3 from TS #3 in GSM frame N+2, and finally, burst #4 from TS #3 in GSM frame N+4. Any transmission of an entire radio block will therefore take 4 frames times 4.615 msecs GSM frame duration, or roughly 20 msecs. Note that when a WTRU is assigned more than 1 TS for reception of data, any of these timeslots contain a separate radio block received over a duration of 20 msecs. The GSM standard defines the timing frame rule specifying exactly when a radio block may start (e.g. which GSM frame contains burst #1). GSM Release 7 provides for the additional possibility of using the RTTI transmission format, where a pair of timeslots in a GSM frame N contains a first set of two (2) bursts, and GSM frame N+1 contains a second set of two (2) bursts of the four (4) total bursts making up the radio block. A transmission using RTTI therefore only takes 2 frames times 4.615 msecs, or roughly 10 msecs. RTTI operation is possible with both EGPRS and EGPRS2. On any given timeslot, BTTI and RTTI WTRUs can be multiplexed while still allowing for the possibility of transmitting the USF to a BTTI WTRU using an RTTI radio block, and vice versa. The GSM standard also allows for the possibility to exclusively assign a timeslot to BTTI-only WTRUs, or exclusively to RTTI-only WTRUs. For legacy EGPRS equipment, RTTI transmissions to reduced latency (RL)-EGPRS WTRUs, multiplexed onto shared timeslots, must respect the legacy USF format and corresponding Stealing Flag settings of legacy BTTI EGPRS WTRUs. Any two RTTI radio blocks sent to RL-EGPRS WTRU in one legacy BTTI time interval must therefore choose exactly the same modulation type (GMSK/GMSK or 8PSK/8PSK) in order not to impact USF decoding ability by the legacy BTTI EGPRS WTRU.

In the case of EGPRS2 RH-A and/or RH-B WTRUs however, in principle, such a limitation to employ exactly the same modulation type does not exist. If such a limitation did not exist, this would permit the EGPRS2 system to achieve higher data throughput because it could independently schedule the appropriate modulation and coding scheme (MCS/DAS/DBS) for the first and second RTTI WTRU on the same BTTI interval. Specifically, a GMSK MCS on the first interval doesn't force the network to send a GMSK MCS on the second RTTI interval such as required in the case of RTTI/BTTI operation with legacy EGPRS WTRUs and therefore reducing the throughput, because an EGPRS2 WTRU can be designed to appropriately handle (use a correcting decoding scheme) this situation. The consequence however is that a BTTI EGPRS2 WTRU may perceive a wide range of possible USF combinations for bursts using a first modulation scheme on the first set of two bursts and another different modulation scheme on the second set of two bursts, thus greatly increasing decoding complexity even beyond the current state-of-the-art. Therefore, the EGPRS2 WTRU is penalized (processing time is increased) because it needs to detect a first modulation type on the first RTTI interval, determine the corresponding first set of USF positions and corresponding USF coding tables, then determine the second modulation type on the second RTTI interval, with a second set of USF positions and respective USF coding tables. As illustrated above, because USF positions vary with every modulation scheme (at least three (3) different sets), the additional RTTI/BTTI modes of operation associated with transmission of EGPRS2 radio blocks result in an undesirably large number of combinations for USF decoding attempts. In some cases (e.g. GMSK), there are even more combinations due to modulation variations between the first or second RTTI interval and because the corresponding USF coding tables vary for each modulation and coding (e.g. MCS/DAS/DBS) scheme (more than five (5) coding tables).

Therefore, procedures are sought to simplify the processing complexity associated with WTRU USF decoding and achieve higher throughput by employing mixed modulation RTTI/BTTI intervals with EGPRS2 transmissions.

### SUMMARY

A method and apparatus allow for reliable and low-complexity decoding of EGPRS2 communication bursts when RTTI and BTTI equipment operate on the same timeslot(s). Various configurations for the Uplink State Flag (USF) mapping employ adjustable bit swapping of some or all USF channel-coded bits in communication bursts. Configurations that allow for an adjustable use of the symbol mapping stage in the transmitter and receiver to allow for more throughput and/or reduced complexity are also disclosed. Admissible mapping rules are known to the receiver and transmitter and therefore reduce the complexity of decoding this information. In order to increase throughput for EGPRS2 communication bursts, RTTI transmissions of different modulation types or EGPRS/EGPRS2 modulation and coding schemes during a BTTI interval are introduced that allow for reliable USF decoding and reduced decoder complexity.

### BRIEF DESCRIPTION OF THE DRAWINGS

A more detailed understanding may be had from the following description,

given by way of example in conjunction with the accompanying drawings wherein:

FIG. 1 is an example of a 3GPP wireless communication system;

FIG. 2 illustrates a functional block diagram of two transceivers, for example, an exemplary WTRU and Node B (or evolved Node B);

FIG. 3 shows burst mapping for USF sent in 20 ms;

FIG. 4 shows burst mapping for MCS-5 and MCS-6;

FIG. 5 shows burst mapping for MCS-7, MCS-8 and MCS-9;

FIG. 6 shows burst mapping of USF in case of RED HOT B (DBS-5 through DBS-12).

FIG. 7A compares a prior art single modulation decoding technique with an embodiment, shown in 7B, that can process and decode from different modulation types;

FIG. 8 is a flow diagram of an example USF decoding procedure;

FIG. 9 shows an embodiment for determining modulation type; and

FIG. 10 shows an embodiment for a decoding procedure for an EGPRS WTRU operating in BTTI mode.

### DETAILED DESCRIPTION

When referred to herein, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to herein, the terminology “base station” includes but is not limited to a Node-B, an evolved Node-B or E-UTRAN Node-B (eNB), a site controller, an access point (AP), or any other type of interfacing device capable of operating in a wireless environment. The variables “x,” “y,” and “z” refer to arbitrary and interchangeable numbers that correspond to a given modulation and coding scheme, for example MCS-x, where x may range from 1 to 9, DAS-y, where y may range from 5 to 12 of DBS-z, where z may range from 5 to 12.

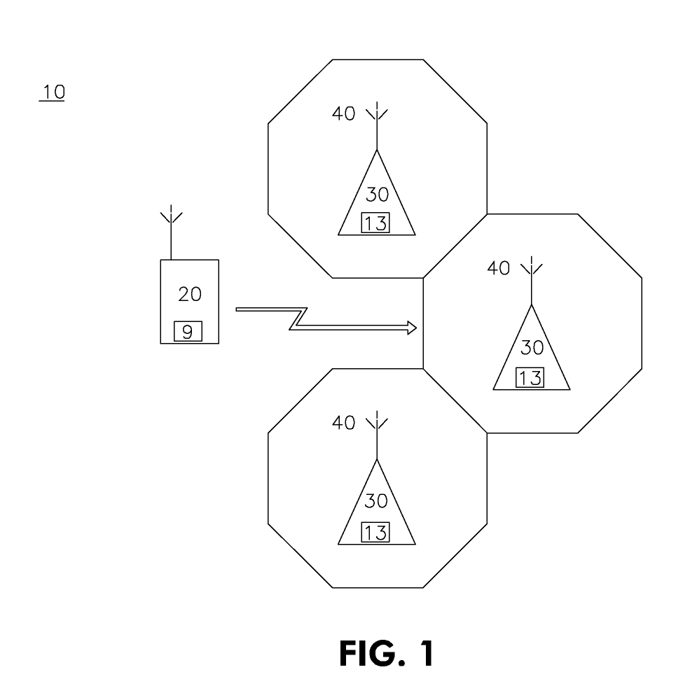

Referring to FIG. 1, a wireless communication network (NW) 10 comprises a WTRU 20, and one or more Node Bs (NB or evolved NB (eNB) 30 in a cell 40. WTRU 20 comprises a processor 9 configured to implement the disclosed methods for coding packet transmissions. Each of the Node Bs 30 has a processor 13 also configured to implement the disclosed methods for coding packet transmissions.

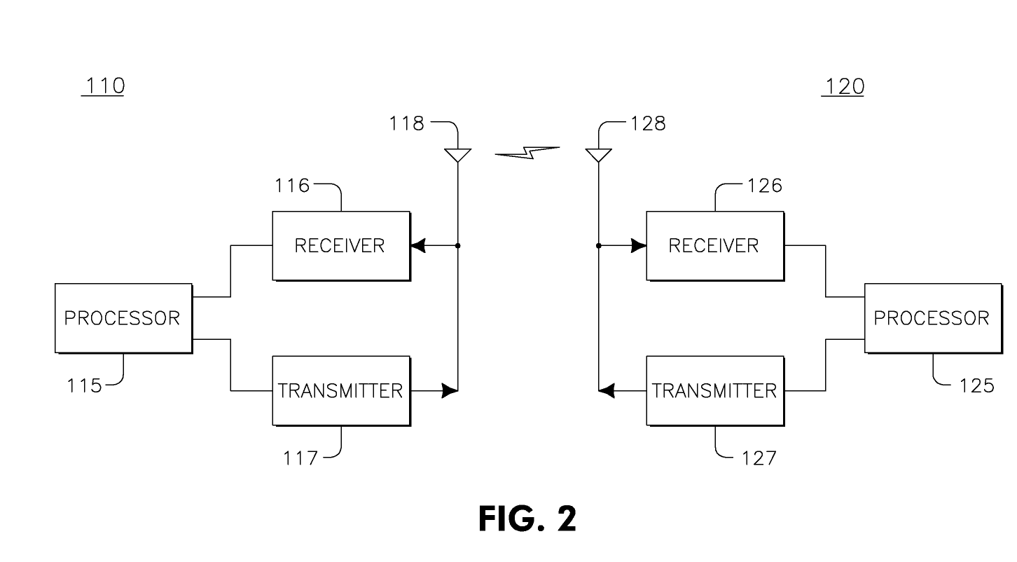

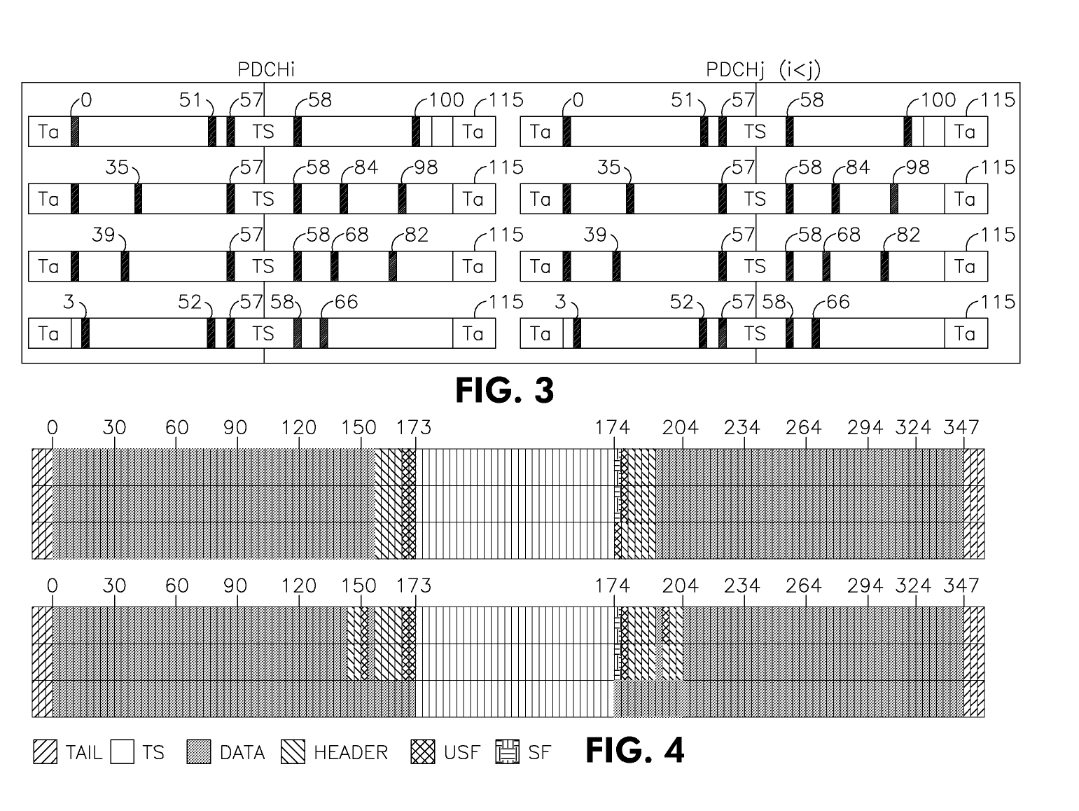

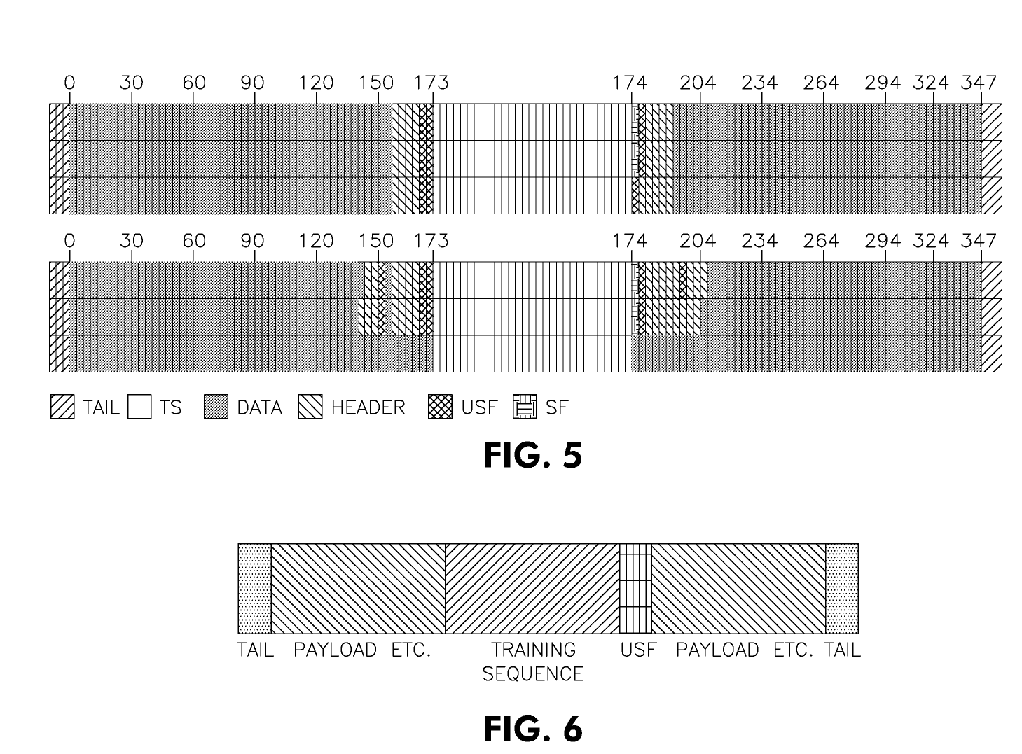

FIG. 2 is a functional block diagram of transceivers 110, 120. In addition to components included in a typical transceiver, e.g., a WTRU or NodeB, transceivers 110, 120 include processors 115, 125 configured to perform the methods disclosed herein; receivers 116, 126 in communication with processors 115, 125 transmitters 117, 127 in communication with processors 115, 125; and antenna 118, 128 in communication with receivers 116, 120 and transmitters 117, 127 to facilitate the transmission and reception of wireless data. Additionally, the receiver 116, transmitter 117 and antenna 118 may be a single receiver, transmitter and antenna, or may include a plurality of individual receivers, transmitters and antennas, respectively. Transmitter 110 may be located at a WTRU or multiple transmitters 110 may be located at a base station. Receiver 120 may be located at either the WTRU, base station, or both.

Bit swapping is employed for RLC/MAC header bits and is recognized as a low-complexity technique employed at the transmitter side to reduce receiver complexity at the decoder side. Bit swapping may be applied to one or more defined USF bit(s)/symbol(s) of the MCS-1 through MCS-4, DAS-5 through DAS-12, and DBS-5 through DBS-12 schemes defined for EGPRS2 DL (REDHOT) transmissions to reduce the overall number of possible combinations.

USF bit(s)/symbol(s) can be swapped with any other position in a burst (e.g. bit(s)/symbol(s)) carrying RLC/MAC header information (data, PAN, etc.). Because the mapping rules applied at encoding are known at the receiver, the bit swapping can be reversed at the receiver side to re-constitute the RLC/MAC header information (data, PAN, etc.). A bit swapping procedure may be coded in a transmitter and a receiver as a mapping rule employed at the burst formatting stage, such as “exchange” (swap) bit B_n1 against B_m1, bit B_n2 against B_m2, and so on.

Full or partial bit swapping is applied to the REDHOT version of EGPRS such as the MCS-1 through MCS-4 schemes which employ CS-4 type USF coding and mapping to the new REDHOT Level A (RH-A) schemes DAS-5 through DAS-7 which employ MCS-5 through MCS-9 type USF coding and mapping (e.g. EGPRS2) into bit/symbol positions of other REDHOT burst types.

Either all or a chosen subset of the USF bits encoded using MCS-1 through MCS-4, and/or RH-A DAS-5 through DAS-7 schemes, may be swapped into either all, or a subset of symbol/bit positions following the training sequence, similar to RH-B DBS-5 through DBS-12 encoding, to reduce the overall number of USF bit position combinations and to commensurately reduce WTRU implementation complexity.

Bit swapping of one or more EGPRS or new REDHOT modulation and coding schemes is applied to the current defined bit positions of the coded USF bits, applied to another one, or to another chosen subset of MCS-1 through MCS-4, DAS-5 through DAS-12 and/or DBS-5 through DBS-12 schemes in order to reduce the overall number of USF mapping constellations to symbols/bits into bursts for REDHOT transmissions.

For the discussion below, the term “N” represents the resulting channel coded bits derived from the 3 USF information bits; NX(X=1,n) are the channel coded bits derived from the three (3) USF information bits based on coding rule X; and PX (X=1,n) are the bit positions upon which the NX bits will be mapped (swapped). The value n represents the number of a coding rule. While the examples below refer to 3 coding rules, there could be any number of coding rules, thus n can represent any integer value.

USF coding rules may be applied to a particular EGPRS or EGPRS2 MCS. When the MCS is sent in BTTI configuration, a first USF coding rule is applied describing: (a) how to derive N1 channel-coded USF bits from the three (3) USF information bits; and (b) specifying into which set of bit positions {P1} to map these N resulting bits in bursts B0, B1, B2 and B3 of the Radio Block. However, when the MCS is sent in RTTI configuration, a second USF coding rule is applied, describing: (a) how to derive N2 channel-coded USF bits; and (b) the set of bit positions {P2}. N1 and N2, and {P1} or {P2} may partially be the same. A transmitter that intends to send a Radio Block using RTTI configuration using the second USF coding rule can implement the following process: the transmitter encodes the Radio Block assuming that it was sent in BTTI mode using the first USF coding rule. Subsequently, as long as N1=N2, the transmitter swaps the bits contained on bit positions {P1} with the bits contained in bit positions {P2}. Alternatively, if the MCS is sent in RTTI/BTTI mixed configuration, a third USF coding rule N3, {P3} is applied.

The receiver (WTRU) unambiguously knows how to decode the USF in a received Radio Block. RLC/MAC setup signaling indicates to the WTRU whether the received Radio Blocks operate in BTTI, RTTI or RTTI/BTTI mode, and this indicates the particular USF coding rules that must be applied by the WTRU in order to decode the USF. In the cases mentioned above, the USF coding rules could be identical. For example, the first USF coding rule, the second USF coding rule or the third coding rule may be the same rule.

A subset of the current USF bit/symbols and/or their positions may be swapped into the USF bit/symbol positions of another REDHOT or EGPRS scheme. Alternatively, the entire set of USF bits/symbols and/or their positions are swapped into those of another EGPRS or REDHOT scheme.

The USF bit/symbol positions may be swapped, using EGPRS MCS-1 through MCS-4 when transmitted on REDHOT packet data channel (PDCH)s, from {0,50,100} on the first burst, {34,84,98} in the second burst, {18, 68, 82} in the third burst, and {2,52,66} 4th burst of the radio block to either all or a subset of new positions {150, 151, 168-169, 171-172, 177, 178 and 195} by applying EGPRS MCS-5 through MCS-9 (and DAS-5 through DAS-7) on each burst. As is obvious to those skilled in the art, the sixteen (16) USF coded bits of MCS-1 through MCS-4 may either be directly mapped onto a subset of these chosen bit positions, or to the same positions.

Alternatively, a similar simple mapping extension technique can be employed to derive thirty-six (36) bits using MCS-5 through MCS-9 from the three (3) USF bits or the sixteen (16) USF coded bits (if MCS-1 through MCS-4 schemes are used).

The USF bit/symbol positions defined by EGPRS DAS-5 through DAS-7 (currently the same as EGPRS MCS-5 through MCS-9) {150, 151, 168-169, 171-172, 177, 178 and 195} may be swapped during each burst into the USF bit/symbol positions corresponding to RH-A DAS-8 through DAS-12 (i.e. the three (3) symbols immediately following the training sequence).

The USF bit/symbol positions of EGPRS MCS-1 through MCS-4, and/or DAS-5 through DAS-7 or a combination of these schemes may be swapped into the USF bit/symbol positions corresponding to RH-A DAS-8 through DAS-12 (i.e. the three (3) symbols immediately following the training sequence). For example, when choosing to bit swap USF bit positions of MCS-1 through MCS-4 and DAS-5 through DAS-7 to the defined USF positions of DAS-7 through DAS-12 schemes, two (2) different bit swap associations and USF coded bit repetition/extension schemes are utilized.

The USF bits/symbol encoding/mapping procedure of either one or a subset of MCS-x, DAS-y, or DBS-z, may be changed to that of another coding scheme or subset of coding schemes. For example, the number of USF coded bits of one or more MCS-x, DAS-y, DBS-z is reduced or increased from N1 to N2 bits. This causes the USF to be aligned according to the decoding scheme of at least one other MCS-x, DAS-y, or DBS-z, reducing the number of possibilities (possible combinations) and decoding complexity.

Alternatively, the USF codeword generation procedure/encoding table of either one or a subset of MCS-x, DAS-y, or DBS-z is changed to that of another coding scheme to reduce the number of possible combinations to decode against.

Alternatively, the approach chosen to map the USF coded bits into symbols of one or a subset of MCS-x, DAS-y, or DBS-z schemes is aligned with those of one other or another subset of MCS-x, DAS-y, or DBS-z schemes, as a subset coding scheme or a derivative of it to reduce the overall number of USF configurations that are possible compared to the EGPRS/EGPRS2 baseline format.

One or more of the RH-A schemes may be aligned to RH-B schemes. For example, the USF symbols/code words of QPSK-based DBS-5 and DBS-6 are reduced to the corresponding USF symbols/code words of 16/32QAM-based DAS-8 through DAS-12/DBS-7 through DBS-12 (or vice versa) to align RH-A and RH-B schemes. The immediate benefit is that the number of mixed modulation constellations is reduced to a total of 4.

In another embodiment, the USF bit/symbol mapping procedure and/or USF codeword generation, for either a particular or a selected subset of EGPRS MCSs, and/or EGPRS2 DAS-x or DBS-y modulation and coding schemes, is used to code the radio block into a BTTI or RTTI transmission depending on if a BTTI and a RTTI WTRU are multiplexed onto the same PDCH resource. For example, a USF bit/symbol mapping procedure and/or a USF codeword generation, to one or more MCS-x, DAS-y and/or DBS-z scheme is changed according to the baseline BTTI format when used to encode the same Radio Block if it is sent in RTTI mode, or BTTI mode, or BTTI/RTTI coexistence mode.

In one embodiment, USF bit/symbol encoding schemes and/or USF codeword generation tables of one or more MCS-x, DAS-y, or DBS-z are based on those of another scheme (e.g. MCS-x, DAS-y, or DBS-z). For example, full or partial repetition of burst-wise portions of the USF encoding tables, or deterministic mapping rules, all of which are equivalent, may be used to implement this process in a transmitter and in a receiver.

The WTRU implements a procedure where, depending on the configuration messages received from the network, such as temporary block flow (TBF) DL assignment and similar messages, as obvious to those skilled in the art, a receiver is configured to decode legacy EGPRS MCS-1 through MCS-4 depending on whether the packet data channel (PDCH) is assigned to EGPRS operation or REDHOT operation. In the first case, EGPRS bursts are received and processed using conventional methods. In the second case, the WTRU configures its decoder to take into account the presence of any USF decoding technique such as bit-swapping, extension on USF bits/symbols, etc. as described above.

As is obvious to those skilled in the art, the methods of applying bit swapping to USF bits/symbols in MCS-1 through MCS-4, DAS-5 through DAS-12, and DBS-5 through DBS-12 to reduce the overall number of possible combinations can be extended or applied individually when allowing for the possibility of GERAN Latency Reduction (LATRED) in R7, i.e. taking into account RTTI operation with RH-A or RH-B.

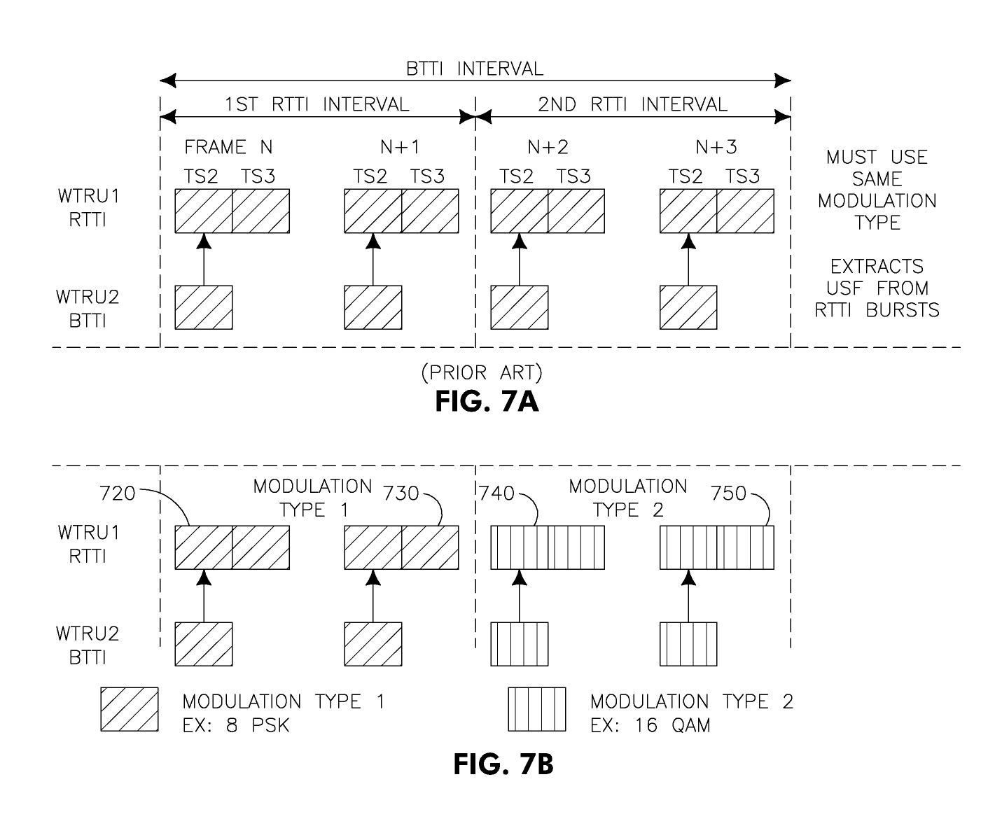

EGPRS2 WTRUs, operating in BTTI-mode, may decode the USF from a first RTTI transmission that possibly uses a different modulation type/set of EGPRS or EGPRS2 modulation and coding schemes, when compared with the second RTTI transmission during the BTTI time period on the assigned timeslot(s). FIG. 7B shows a comparison of this embodiment with the prior art in FIG. 7A. FIG. 7B shows 4 frames (N to N+3), and each frame contains two time slots (TS2 and TS3) carrying two (2) out of four (4) bursts making up a Radio Block. In FIG. 7A, each time slot out of the four (4) making up the entire Radio Block must have the same modulation type, thus the first frame consisting of the first two (2) bursts and the second frame containing the last two (2) burst of the RTTI transmission have the same modulation type.

As shown in FIG. 7B, the frame containing the first two (2) bursts and the frame containing the second two (2) bursts of an RTTI transmission may have different modulation types. In this case, the WTRU1 extracts the USF from four bursts when the modulation type of the first two frames is different from the modulation type of the second two frames. In this example, for illustration purposes, the first frame 720 and the second frame 730 are encoded using 8PSK modulation, and the third frame 740 and the fourth frame 750 are encoded using 16QAM. By processing all 4 bursts, WTRU1 is able to properly decode the USF.

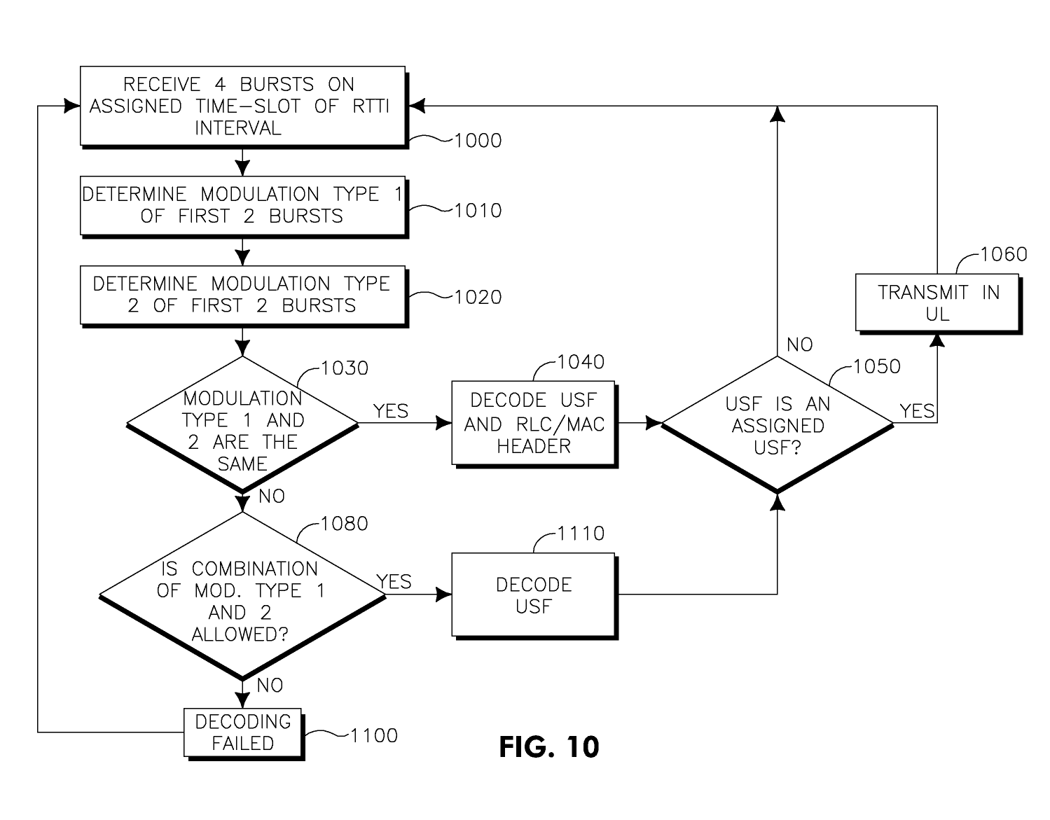

Another embodiment of a USF decoding procedure is shown in FIG. 10. At 1000, a WTRU (or other receiving device) receives four (4) bursts on the assigned time slot of a BTTI interval. The modulation type (Type1) of the first two (2) bursts is determined at 1010. The modulation type (Type2) of the second two (2) bursts is determined at 1020. Alternatively, the modulation type of one or more received bursts in the first set can be determined while the WTRU is still receiving, or processing, on or more bursts in the second set.

The modulation types (Type1 and Type2) are compared at 1030 and if they are the same, the USF and RLC/MAC header are decoded at 1040. If the USF is the assigned USF at 1050, then data may be transmitted on the uplink channel. If the USF is not the assigned USF, then the WTRU waits to receive another four (4) bursts at 1000.

If the modulation types are not the same at 1030, then at 1080 it is determined if the particular modulation combination (Type1 combined with Type2) is allowed. If so, the USF is decoded at 1110. Then, at 1050, the decoded USF is compared against the assigned USF and if they are the same, data may be transmitted on the uplink channel. If the USF is not the assigned USF then the WTRU waits to receive another four (4) bursts at 1000.

If the modulation combination at 1080 is not allowed then decoding fails and the WTRU waits to receive another four (4) bursts at 1000.

Alternatively, admissible modulation types (or in an equivalent manner, admissible subsets taken from MCS-x, DAS-y, DBS-z) in a first and in a second RTTI interval are un-restricted. In this case, the receiver proceeds right to the USF decoding step in 1110.

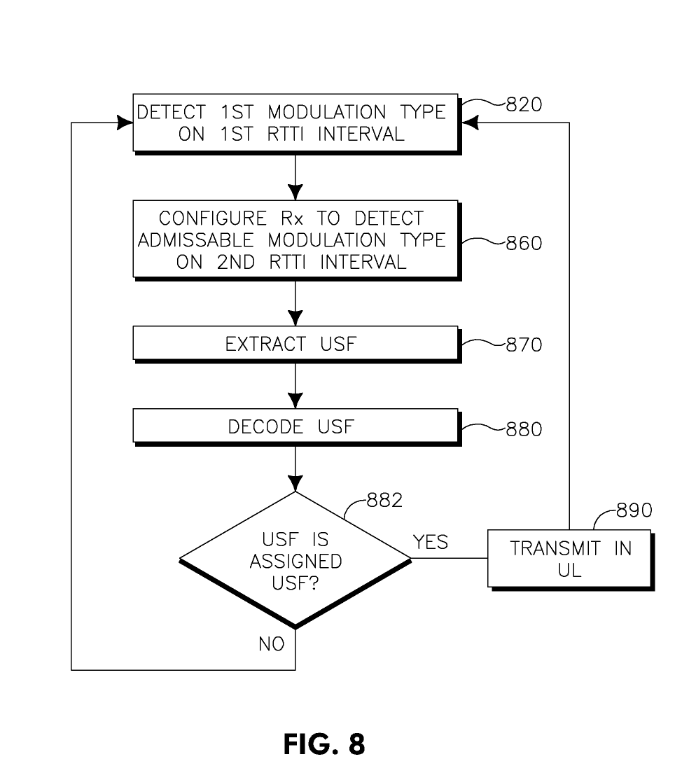

In another embodiment, admissible modulation types (or in an equivalent manner, admissible subsets taken from MCS-x, DAS-y, DBS-z) in a first and in a second RTTI interval are restricted. The restriction may depend on the choice of the modulation type (or subsets of MCS-x, DAS-y, DBS-z) in the first or in the second RTTI interval, during a BTTI interval, in order to reduce the number of possible combinations that must be processed by the receiver in order to decode the USF. An exemplary flow diagram of this embodiment is shown in FIG. 8. At 820, the first modulation type of the first RTTI interval is detected. At 860, the receiver (Rx) is configured to detect admissible modulation types on the second RTTI interval. At 870, the USF is extracted. At 880, the USF is decoded. Then at 882, the decoded USF is compared with the assigned USF and if they are equal (the same) data may be transmitted in the uplink (UL) 890, otherwise detection 820, configuration 860, extraction 870, and decoding 880 are repeated.

The restriction to one or more given modulation types (GMSK, 8PSK, QPSK, 16QAM, 32QAM) is equivalent to a restriction onto specifically chosen subsets of MCS, DAS and/or DBS modulation and coding schemes. For example, restriction of the modulation type to GMSK-only is equivalent to allowing CS-1 through CS-4 and MCS-1 through MCS-4 only. Modulation type 8PSK includes MCS-5 through MCS-9 and DAS-5 through DAS-7. Modulation type 32QAM comprises DAS-10 through DAS-12 and DBS-10 through DBS-12.

The restriction of possible modulation types or subsets of modulation and coding schemes, that can occur on the first or the second RTTI interval (or chosen subset of MCS-x, DAS-y, DBS-z) may be given by a rule implemented in either the network, WTRU, or both. The restriction of possible combinations of the second RTTI interval depends on the modulation type, or subsets of modulation and coding schemes occurring during the preceding first RTTI interval. Alternatively, the restriction of possible combinations of the first RTTI interval depends on the modulation type, or subsets of EGPRS or EGPRS2 modulation and coding schemes occurring during the second RTTI interval (the following RTTI interval). Alternatively, the restriction is imposed on admissible modulation types or subsets of modulation and coding schemes for the first and the second RTTI interval. Preferably, the restriction rules are fixed and known both to the WTRU and the network. Alternatively, the restriction rules can be configured through signaling, such as for example RLC/MAC messages used to establish radio links, TBF's, or that assign radio resources.

Furthermore, the restriction of possible modulation types, or subsets of EGPRS or EGPRS2 modulation and coding schemes, that can follow each other in subsequent RTTI intervals may depend on the capability set that a particular WTRU supports. Because a RH-A WTRU is not required to decode the USF from RH-B DBS-z schemes, the RH-A WTRU may utilize a different set of restrictions in contrast to a RH-B WTRU (that needs to decode against a higher number of combinations). The restriction, imposed on the admissible modulation types or (sub)sets of EGPRS or EGPRS2 modulation and coding schemes, may be chosen as a function of the USF codewords and their minimum Hamming distance when partial codewords of two (2) different modulation types are paired, in order to eliminate and exclude certain pathologic cases (very low Hamming distance between codeword combinations in the sense of an outlier) to improve upon USF detection performance in the general case.

The following table illustrates one example of how such a restriction on admissible modulation types or (sub)sets of EGPRS or EGPRS-2 modulation and coding schemes. This specific example gives the list of allowed versus disallowed modulation types in a second RTTI interval (horizontal) as a function of the modulation type employed on the first RTTI interval (vertical). This illustrative example represents only one possible trade-off and is extendable to the other possible trade-offs between a decrease in throughput versus decoding simplification compared to the general case (where in principle any modulation type can follow any other).

| 1^{st} RTTI/ | | | | | |
|---|---|---|---|---|---|
| 2^{nd} RTTI | | | | | |
| interval | GMSK | 8PSK | QPSK | 16QAM | 32QAM |
| OMSK | Yes | Yes | No | Yes | Yes |
| 8PSK | Yes | Yes | Yes | No | No |
| QPSK | No | Yes | Yes | Yes | Yes |
| 16QAM | Yes | No | Yes | Yes | Yes |
| 32QAM | Yes | Yes | Yes | Yes | Yes |

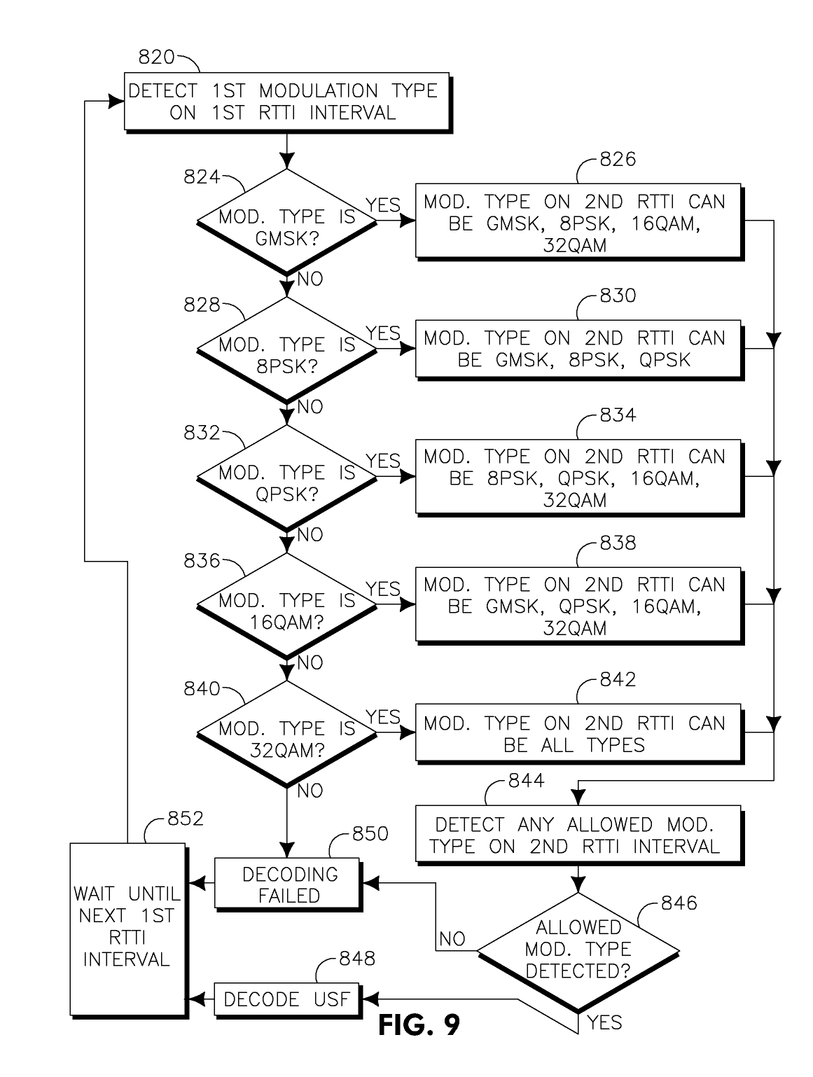

FIG. 9 shows a flow diagram of such an exemplary restriction embodiment (and also represents a depiction of what occurs in detection 820 in FIG. 8). The detection 820 of the modulation type on the first RTTI begins at 824, where the first RTTI interval is tested to determine if it is GMSK modulation. If the determination is positive, then at 826 the second RTTI interval may be any one of the following modulation types: GMSK, 8PSK, 16QAM or 32QAM. If not, the first RTTI interval is similarly tested to determine if it is 8PSK at 828. If the determination is positive, then at 830 the second RTTI interval may be any one of the following modulation types: GMSK, 8PSK or QPSK. Otherwise the process continues to test the first RTTI interval to determine if it is QPSK at 832. If the determination is positive, then at 834 the second RTTI interval may be any one of the following modulation types: 8PSK, QPSK, 16QAM, or 32QAM. Otherwise the process continues to test the first RTTI interval to determine if it is 16QAM at 836. If the determination is positive, then at 838 the second RTTI interval may be any one of the following modulation types: GMSK, QPSK, 16QAM or 32QAM. Otherwise the process continues to test the first RTTI interval to determine if it is 32QAM at 840. If the determination is positive, then at 842 the second RTTI interval may be all types. Next, the modulation type on the second RTTI is detected at 844 and tested to determine if it is an allowed modulation type at 846. If the determination is positive, the USF is decoded at 848 and data may be subsequently transmitted on the uplink. Otherwise, the USF is not decoded 850 and data is not transmitted. In either case, the process waits for the next RTTI interval (data transmission).

There may be more than one set of restriction rules (equivalent to allowed modulation type transitions between the first RTTI and second RTTI intervals) employed in the system. The restriction rules may depend on the type and capabilities of the WTRU multiplexed onto a particular PDCH resource. In the case of single restriction rule or where there are a set of restriction rules (multiple rules), such restriction rules may be signaled to the WTRU during the TBF/resource establishment/assignment phase, or similarly communicated through an extension of EGPRS RLC/MAC signaling messages, or be given by fixed rules implemented in WTRU and/or network. This could include messages such as, PACKET DOWNLINK ASSIGNMENT, MULTIPLE TBF DOWNLINK ASSIGNMENT, PACKET UPLINK ASSIGNMENT, MULTIPLE TBF UPLINK ASSIGNMENT, PACKET TIMESLOT RECONFIGURE, MULTIPLE TBF TIMESLOT RECONFIGURE, or PACKET CS RELEASE INDICATION messages.

In another embodiment, different stealing flag settings may be applied to either one or chosen subset of EGPRS or EGPRS2 MCS-x, DAS-y and/or DBS-z EGPRS2 transmissions to assist the receiver in determining the correct USF decoding format, order of a Radio Block in a RTTI or BTTI or mixed RTTI/BTTI interval, or if the USF decoding format is changed compared to a baseline encoding case such as a BTTI transmission, or if the received burst(s) or radio blocks belong to a first or a second RTTI interval in a BTTI interval (where eventually different settings of some burst portions may apply). This may include a RTTI USF mode indication with/without BTTI coexistence (if such a feature is supported). For example, one or more different stealing flag configurations for an EGPRS2 MCS-x, DAS-y and/or DBS-z radio block (or per time period) may be used to indicate one or more of the following: the correct USF format to decode against and to help the receiver determine the correct USF decoding format to test the received burst(s), radio blocks, etc., USF sent in BTTI configuration, USF sent in RTTI configuration, USF sent in RTTI configuration using BTTI coexistence mode, and received Radio Block corresponds to 1st versus 2nd RTTI interval in a BTTI interval.

For illustration purposes, and without loss of generality, stealing flags may be set as follows in the case of DAS-8/9 in its 1st/2nd consecutive RTTI interval,

| | in the first 10 ms | in the second |
|---|---|---|
| | of a 20 ms block | 10 ms of a 20 ms |
| | period | block period |
| RTTI USF sent in BTTI | 0, 0, 0, 0, 1, 1, 1, 1 | 1, 1, 1, 1, 0, 0, 0, 0 |
| coexistence mode | | |

| | |
|---|---|
| RTTI USF sent in RTTI- | 0, 0, 0, 0, 0, 0, 0, 0 |
| only USF mode | |

The specific value of a given stealing flag codeword chosen to indicate a particular USF mode could be any particular value as long as such value is unique with respect to the indicated context/mode.

For different sets of EGPRS2 MCS-x, DAS-y and/or DBS-z modulation and coding schemes, distinct stealing flag configurations may be employed.

There are many different and equivalent ways of aligning USF coding and position mapping of USF bits/symbols in MCS-1 through MCS-4, DAS-5 through DAS-12, DBS-5 through DBS-12 to reduce and align them for the different burst types in a WTRU implementation.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method of reducing uplink state flag (USF) symbol decoding complexity, the method comprising:
generating a radio burst for transmission using a plurality of modulation and coding schemes (MCSs);
mapping USF bits of a first of the plurality of MCSs onto the radio burst according to a USF bit mapping scheme of a second of the plurality of MCSs.

2. The method of claim 1, wherein the mapping includes bit swapping USF bits.

3. The method of claim 1, wherein the first of the plurality of MCSs is an enhanced general packet radio service 2 (EGPRS2) MCS and the second of the plurality of MCSs is a EGPRS2 downlink level A or an EGPRS downlink level B scheme.

4. The method of claim 1, wherein the mapping includes positioning USF bits immediately following a training sequence.

5. The method of claim 4 further comprising:
encoding the mapped USF bits using one of MCS-1 through MCS-4 or one of EGPRS2 downlink level A (DAS)-5 through DAS-9 schemes.

6. The method of claim 1, wherein the mapping is based upon a transmission time interval (TTI) of the radio burst.

7. The method of claim 6, further comprising:
determining whether the TTI is a basic TTI (BTTI) or a reduced TTI (RTTI); and
mapping USF bits of a first of the plurality of MCSs onto the radio burst according to a USF bit mapping scheme of a second of the plurality of MCSs based on the determination.

8. The method of claim 1, wherein the mapping is signaled to a wireless transmit/receive unit (WTRU) for proper reconstruction.

9. A wireless transmit/receive unit (WTRU) comprising:
a receiver configured to receive a radio burst including uplink state flag (USF) bits modulated according to a plurality of modulation and coding schemes (MCSs); and
a processor configured to recover USF bits modulated according to a first of the plurality of MCSs using a USF bit mapping scheme associated with a second of the plurality of MCSs.

10. The WTRU of claim 9, wherein the USF bit mapping scheme includes bit swapping USF bits.

11. The WTRU of claim 9, wherein the first of the plurality of MCSs is an enhanced general packet radio service 2 (EGPRS2) MCS and the second of the plurality of MCSs is a EGPRS2 downlink level A or an EGPRS downlink level B scheme.

12. The WTRU of claim 9, wherein the processor is further configured to detect USF bits immediately following a training sequence.

13. The WTRU of claim 12, wherein the processor is further configured to decode the USF modulated bits using one of MCS-1 through MCS-4 or one of EGPRS2 downlink level A (DAS)-5 through DAS-9 schemes.

14. The WTRU of claim 9, wherein the processor is configured to recover the USF bits based upon a transmission time interval (TTI) of the radio burst.

15. The WTRU of claim 14, wherein the processor is further configured to:
determine whether the TTI is a basic TTI (BTTI) or a reduced TTI (RTTI); and
recover USF bits of a first of the plurality of MCSs according to a USF bit mapping scheme of a second of the plurality of MCSs based on the determination.

16. The WTRU of claim 9, wherein the receiver is further configured to receive information regarding a MCS used to map the USF bits onto the radio burst.

17. A method of reducing uplink state flag (USF) symbol decoding complexity, the method comprising:
receiving four bursts on an assigned time slot of a basic transmission time internal (BTTI);
determining a first modulation type of the first two bursts;
determining a second modulation type of the second two bursts;
determining if the first modulation type is identical to the second modulation type;
decoding the USF and a radio link control (RLC)/medium access control (MAC) header in response to a positive determination;
transmitting uplink data on the uplink channel in response to a positive determination that the decoded USF is an assigned USF; and
waiting to receive another radio block in response to a negative determination that the decoded USF is an assigned USF.

18. The method of claim 17 further comprising:
determining if a combination of the first modulation type and the second modulation type is an allowed combination in response to a negative determination that the first modulation type is identical to the second modulation type;
transmitting uplink data on the uplink channel in response to a positive determination that the combination is allowed; and
waiting to receive another radio block in response to a negative determination that the combination is allowed.

19. The method of claim 18, wherein the allowed combination is received at a wireless transmit/receive unit.

20. The method of claim 18, wherein the allowed combination is based on a preceding reduced transmission time interval (RTTI).

21. The method of claim 20, wherein the allowed combination is further based on a modulation and coding scheme (MCS) of the preceding RTTI.

22. The method of claim 20, wherein the allowed combination is based on a future RTTI.

23. The method of claim 22, wherein the allowed combination is further based on a MCS of the future RTTI.

24. The method of claim 18, wherein the allowed combination is based on a minimum Hamming distance of USF codewords.

25. The method of claim 18, wherein the allowed combination is based on the capabilities of a wireless transmit/receive unit (WTRU).

26. The method of claim 19, wherein the allowed combination is received at the WTRU in a message selected from the group consisting of: a packet downlink assignment message; a multiple temporary block flow (TBF) downlink assignment message; a packet uplink assignment message; a multiple TBF uplink assignment message; a packet timeslot reconfigure message; a multiple TBF timeslot reconfigure message; and a packet coding scheme (CS) release indication message.
